(19) United States
(12) Patent Application Publication
(10) Pub. No.: US 2024/0354123 A1
(43) Pub. Date: Oct. 24, 2024

(54) COMMUNICATION SYSTEM CONFIGURED TO COMMUNICATE WITH VEHICLES OF A SET OF VEHICLES

(71) Applicant: AMPERE S.A.S., Boulogne Billancourt (FR)

(72) Inventors: Matthieu BAGLIN, Guyancourt cedex (FR); Julie DARAGNES, Guyancourt cedex (FR); Sebastien GONZALVE, Guyancourt cedex (FR)

(73) Assignee: AMPERE S.A.S., Boulogne Billancourt (FR)

(21) Appl. No.: 18/721,759

(22) PCT Filed: Nov. 24, 2022
(86) PCT No.: PCT/EP2022/083195

§ 371 Date: Jun. 19, 2024

(30) Foreign Application Priority Data
Dec. 20, 2021 (FR) FR2114002

(51) Int. Cl. G06F 9/445; G07C 5/00; H04L 67/12

(52) U.S. Cl. CPC G06F 9/44594; G07C 5/008; H04L 67/12

(57) ABSTRACT

A communication system includes: a unit for recording and storing a plurality of information items transmitted by a plurality of vehicles of a set of vehicles, an element for identifying and classifying signatures representative of malfunctions with applications on board the vehicles, a parameterization unit that compares an occurrence parameter of signatures representative of malfunctions with an application with a first predetermined threshold, and/or that compares a stability parameter of this application with a second predetermined threshold, and a communication element to transmit, to at least one vehicle of the set of vehicles, an order to deactivate an application based on the result of the comparisons carried out by the parameterization unit.

The invention relates to the field of applications on board motor vehicles. It relates more particularly to a device and a method for managing such applications.

The number of applications on board motor vehicles is constantly increasing, be these applications intended to manage and/or control the operation of the vehicle, such as for example applications for launching the on-board computer or for communicating with remote servers, or applications intended to manage the active safety of the vehicle, such as for example braking control applications, or guidance applications, for example satellite guidance, or applications relating to the comfort of the occupants of the vehicle, such as for example applications for personalizing the driver's environment through seat adjustment and/or heating.

The proliferation of these applications and the ever-increasing proportion of the electronics involved in managing and controlling the operation of the vehicle make it difficult, or even impossible, to test the operation of all of these applications for the multiplicity of configurations in which these applications are required to operate.

This means that certain application malfunctions are difficult to predict and, therefore, to resolve, independently of use in an actual situation of the vehicle. However, such malfunctions may lead firstly to excessive consumption of energy by the vehicle, for example in the case of an application exhibiting a malfunction when it is started and that the central control device of the vehicle will repeatedly attempt to start, and secondly to greater malfunctions of other applications, through a form of cascade effect.

The technical problem to which the present invention proposes to provide a solution is that of managing such malfunctions.

To achieve its aim, one subject of the invention, according to a first aspect, is a communication system configured to communicate with the vehicles of a set of motor vehicles, characterized in that it comprises:
a unit for recording and storing a plurality of items of information transmitted by a plurality of vehicles of the set of vehicles,
a member for identifying and classifying, among the items of information transmitted by a plurality of vehicles of the set of vehicles, signatures representative of malfunctions of applications on board the vehicles,
a unit configured to compare, for one of the applications for which at least one signature has been identified and classified, an occurrence parameter in relation to signatures representative of malfunctions of this application with a first predetermined threshold, and/or to compare a stability parameter in relation to this application with a second predetermined threshold,
a communication member configured to transmit, to at least one vehicle of the set of vehicles, an order to deactivate an application based on the result of the one or more comparisons carried out by the unit.

It should first be understood here that the vehicles of the set of vehicles may be identical to one another or different from one another. Similarly, it should be understood here that the communication system according to the invention is not physically located on any of the vehicles of the set of vehicles, but that it is located at a distance from said vehicles with which it is configured to communicate.

Moreover, the term “on-board application” here designates an application intended to operate on all of the vehicles of the set of vehicles, whether or not these are identical to one another, as soon as these vehicles are turned on, whether or not they are moving. By way of non-exhaustive examples, the on-board applications may include applications relating to the safety of the vehicle, such as for example trajectory management applications or braking management applications, applications relating to the possibility for the vehicle to communicate remotely, for example with the communication system according to the invention, or applications intended to improve the comfort of the occupants of the vehicle, such as heating or air conditioning management applications, geolocation and/or guidance applications. It is thus possible to define various types of applications depending on the purpose thereof.

According to the invention, items of information are transmitted between the vehicles and the communication system over the Internet or via a vehicle-specific communication protocol, for example via a cellular network.

It should also be understood here that each malfunction of an application generates the creation of a specific item of information, representative of the malfunction that has occurred, intended for the recording and storage unit of the system according to the invention. More precisely, the specific item of information, also designated as a signature hereinafter, takes the form of at least one line of source code and comprises firstly a datum relating to the identification of the application that has exhibited a malfunction, and secondly a datum relating to the nature of the malfunction that has occurred. By way of non-exhaustive examples, the datum relating to the nature of the malfunction may be for example a starting not possible item of information, an execution error item of information, an error in the communication of one or more data item of information, etc.

According to one optional feature of the invention, the specific item of information, or signature, may contain a geolocation datum in order to facilitate the analysis of the malfunction, where applicable.

The identification and classification member, which retrieves all of the information stored by the recording and storage unit, is configured to read the lines of code of each of the items of information fed back thereto and is configured to detect a specific form of a line of code, for example through the presence of a specific marking at the start or at the end of a line, without this limiting the invention, and classify it as signatures representative of a specific malfunction for a given application.

The invention therefore proposes to identify and classify the signatures of malfunctions of the applications on board all of the vehicles of the set of vehicles defined above. According to various examples, these signatures may be classified by application, by type of application (applications relating to the safety of the vehicle, applications relating to the comfort of the occupants, etc.), or by nature of the malfunction.

According to the invention, the occurrence parameter is representative of a number of occurrences of the signatures defined above. Comparing this occurrence parameter with a threshold value, here a first threshold, makes it possible to trigger preventive actions on the fleet of vehicles associated with this communication system as soon as the occurrence parameter has a particular value with respect to an alert threshold.

According to various features, taken separately or in combination:
the occurrence parameter is a value representative of a number of occurrences of the set of signatures representative of a malfunction of one and the same application.
the occurrence parameter is a value representative of a number of occurrences of a defined signature; in other words, this occurrence parameter is representative of a number of occurrences of a specific malfunction of a given application.
the occurrence parameter is computed by multiplying the number of occurrences of a defined signature by the number of vehicles affected by the occurrence of this signature, or else by multiplying the number of occurrences of the set of signatures representative of a malfunction of one and the same application by the number of vehicles affected by the occurrence of these signatures. Obtaining this occurrence parameter taking into account the number of vehicles affected makes it possible to ensure that the occurrence of large numbers of signatures is not localized on a small number of vehicles and that an application will not be deactivated for an entire fleet of vehicles on the basis of a malfunction occurring in a loop on a single vehicle.
the first threshold has an identical value for all of the signatures of all of the applications.
the first threshold has a value defined for each signature of each application, the value of the first threshold being able to vary from one signature to another, in particular depending on the degree of criticality of the corresponding application.
the first threshold has a value defined for each type of application, that is to say a first threshold may have an equal value for all of the signatures of malfunctions of all of the applications of a given first type, and another, distinct first threshold may have a distinct value that applies to the set of signatures of an application of another type of application.

According to the invention, the stability parameter is representative of a duration between two successive occurrences of a signature as defined above. Comparing this stability parameter with a threshold value, here a second threshold, makes it possible to trigger preventive actions on the fleet of vehicles associated with this communication system as soon as the stability parameter has a particular value with respect to an alert threshold.

Similarly to what has been explained for the first threshold, according to various features, taken separately or in combination:
the second threshold has an identical value for all of the signatures of all of the applications,
the second threshold has a value defined for each signature of each application, the value of the second threshold being able to vary from one signature to another, in particular depending on the degree of criticality of the corresponding application,
the second threshold has a value defined specifically for each type of application, that is to say a second threshold may have a value that applies to all of the signatures of malfunctions of all of the applications of a given first type, and a different, second threshold may have a distinct value that applies to the set of signatures of an application of another type of application.

The deactivation should be understood here to mean a temporary blockage of the operation of an application. According to the invention, such deactivation is carried out when the vehicle is turned on, before the application starts.

The invention makes provision for such deactivation to be able to be carried out in particular for at least one vehicle of the set of vehicles, and in one particular case, for all of the vehicles of the set of vehicles, whether or not the application in question has exhibited one or more malfunctions. In other words, the invention makes provision for the deactivation order to be transmitted to all of the vehicles of the set of vehicles, including those on which the application has not exhibited a malfunction. According to the invention, such deactivation is temporary, until the one or more malfunctions that led to the deactivation of the application under consideration have been resolved. According to various examples, this resolution may occur spontaneously when the vehicle is started subsequently or through the transmission of an update of the application in question to the vehicles by the communication system according to the invention.

The invention therefore makes it possible to selectively deactivate applications that have previously had an excessive number of malfunctions or that have exhibited one or more malfunctions considered to be too close together before they start, on all of the vehicles of the set of vehicles. In other words, the invention makes it possible to preventively deactivate applications that, with regard to their prior operation and prior malfunctions, exhibit a risk of malfunction that is deemed to be too great. This makes it possible firstly to avoid the occurrence of more extensive malfunctions due to a form of cascade effect, and secondly to avoid any degradation of the image of the vehicle and its operation in the eyes of the user, who might be discouraged by repetitive malfunctions and turn to a vehicle from another manufacturer. Finally, this makes it possible to reduce the energy consumption of the vehicle caused by the mobilization of the electronic systems through an excessively great or excessively frequent repetition of the abovementioned malfunctions.

According to the invention, the deactivation of an application on the vehicles of the set of vehicles takes effect as soon as the occurrence parameter has a value greater than the corresponding first threshold value and/or as soon as the stability parameter has a value less than the corresponding second threshold value. In particular, the deactivation of an application may take effect when these two conditions are met, namely excessive occurrence of the malfunction, which suggests that this malfunction may spread to the entire fleet of vehicles, and excessively frequent occurrence of the malfunction, which suggests that the on-board computer of the vehicle in question is attempting to restart the defective application excessively often, which may penalize the operation of other non-defective applications.

The deactivation of an application, via a deactivation order transmitted by the communication member, may be, either systematically or solely depending on the criticality level of the application under consideration, subject to or conditional upon confirmation by the user of the vehicle on which the application is to be deactivated.

According to one feature of the invention, the identification and classification member is configured to assign, to each application on board the vehicles of the set of vehicles, a label representative of a criticality of the application under consideration.

The criticality of an application is advantageously evaluated on the basis of the impact of the operation of this application, respectively and successively:
on the basic operation of the vehicle, that is to say on the operation of the engine, the steering, and the members related to these functions,
on the connectivity of the vehicle, that is to say on the ability of the vehicle to transmit information to a remote communication system such as for example the one provided by the invention, and to receive information from this communication system,
on the safety of the vehicle, that is to say on the operation of safety-related members, such as, by way of non-exhaustive examples, lighting, braking systems, trajectory correction systems, etc.

When an application implements one or more processes related to one or more of the abovementioned functionalities, or when the operation of this application has an impact on one or more of these functionalities, this application is assigned a “critical” label. In all other cases, the invention makes provision for this application to be assigned a “non-critical” label.

It will readily be understood that the classification, explained above, of the signatures defined above may advantageously take into account the criticality label thus defined, and that this criticality label may also advantageously be taken into account when deciding to deactivate an application.

According to one feature of the invention, the communication system comprises a comparison unit that is configured to compare the signature occurrence parameter with the first threshold and/or the stability parameter with the second threshold only for applications that are assigned a certain type of label representative of a criticality of the application under consideration.

Without departing from the context of the invention, it will be possible to envisage the computing unit, the parameterization unit and the comparison unit being one and the same electronic entity that is configured to carry out each of these functions.

According to one feature of the invention, the values associated with the first threshold and/or with the second threshold are functions of the label representative of a criticality of the application under consideration.

According to a second aspect, one subject of the invention is a method for communication between a communication system as has just been described and the vehicles of a set of motor vehicles, characterized in that it comprises:
a step of the vehicles of the set of motor vehicles transmitting, to the recording and storage unit of the communication system, a plurality of items of information relating to the operation of applications on board the motor vehicles,
   a step of identifying and classifying, among the items of information transmitted by the vehicles, signatures representative of malfunctions of one or more applications on board the vehicles,
   a step of analyzing the signatures representative of malfunctions of one or more applications on board the vehicles,
   a step of deactivating, on all of the vehicles of the set of motor vehicles, one or more applications on the basis of the result of the analysis of the signatures representative of malfunctions of these one or more applications.

Advantageously, the step of analyzing the signatures representative of malfunctions, or signatures as defined above, comprises an operation of classifying this information, for example by type of malfunction and/or by application.

The invention also makes provision for the step of analyzing the signatures representative of malfunctions to comprise an operation of counting the number of occurrences of the signatures. According to one example, the counting operation is performed for each signature received by the communication system, that is to say for each type of malfunction of each application. According to another example, the counting operation is performed for the set of signatures associated with each application, that is to say for all of the malfunctions of a given application, without distinction as to the type of malfunction that has occurred. This counting operation makes it possible in particular to compute an occurrence parameter.

The invention furthermore makes provision for the step of analyzing the signatures representative of malfunctions to comprise an operation of measuring a duration between two successive occurrences of the abovementioned signatures, as well as an operation of computing an average of these durations, in order to compute a stability parameter. According to one example, the measured duration is the duration between two successive occurrences of one and the same signature, that is to say between two successive occurrences of a specific malfunction of a given application. In this case, the measured duration represents the time interval between two successive occurrences of one and the same malfunction of a given application. According to another example, the measured duration is the time interval between two successive occurrences of malfunctions of a given application, the two successive malfunctions between which this duration is measured possibly being different. In other words, in this case, the measured duration is the time interval between the occurrence of two identical or different signatures of one and the same application. Regardless of the example chosen, the invention makes provision for an average of the measured durations to be computed in the step of analyzing the signatures representative of malfunctions and for this average of the measured durations to make it possible to obtain a stability parameter.

According to various examples, the counting and the duration measurement as mentioned above may be carried out daily, or they may be carried out between the time when the vehicle starts and the time when it is stopped, regardless of the number of these operations throughout the day.

According to one feature, the method according to the invention comprises a step of assigning a criticality label as defined above to each application on board the vehicles of the set of motor vehicles.

According to another feature, the invention makes provision for the step of analyzing the signatures representative of malfunctions of one or more applications on board the vehicles and/or the step of deactivating an application to be conditional upon the criticality label assigned to this application.

More precisely, the invention makes provision for only applications assigned the “non-critical” label as defined above to be able to be deactivated.

According to one feature, the analysis step comprises computing an occurrence parameter in relation to the signatures representative of malfunctions of an application and comparing this occurrence parameter with a value of a first threshold.

As explained above, the occurrence parameter may be defined as the product of the number of occurrences counted in the analysis step described above by the number of vehicles on which these malfunctions have occurred.

Preferably, the occurrence parameter may be defined by the product of the number of occurrences of a given signature and the number of vehicles that have exhibited the malfunction expressed by this signature. As a variant, and as indicated above, the occurrence parameter may be defined as the product of the number of occurrences of malfunctions of one and the same application and the number of vehicles on which this application has exhibited a malfunction, whatever this may be.

The occurrence parameter is compared with a value of a first threshold. It should be noted that the value of the first threshold depends in particular on the type of computation performed to define the occurrence parameter. By way of non-limiting example, the first threshold may be arbitrarily set to a value of a few hundred, when the occurrence parameter is defined by the number of occurrences of a given signature, and it may be arbitrarily set to a value of a few thousand, when the occurrence parameter is defined by the product of the number of occurrences of a given signature and the number of vehicles that have exhibited the malfunction expressed by this signature.

As a variant, different values may be assigned to the first threshold depending on the application under consideration, or depending on the type of signatures associated with one and the same application. For example, for a signature corresponding to a minor malfunction, not requiring the application to be restarted immediately, the first threshold may be set to a first value of the order of one thousand, whereas, for a signature corresponding to a major malfunction, imperatively requiring the application to be restarted immediately, the first threshold may be set to a second value lower than the first value mentioned above and of only a few hundred.

According to another feature, the analysis step comprises computing a stability parameter in relation to an application and comparing this stability parameter with a value of a second threshold.

The stability parameter is therefore established on the basis of the durations measured in the analysis step described above and on the basis of the averages computed in this analysis step. Preferably, the stability parameter is defined on the basis of an average time interval between two successive occurrences of one and the same signature, that is to say between the occurrence of two successive occurrences of one and the same malfunction for a given application.

By way of non-limiting example, the second threshold may be arbitrarily set to a duration between a few tens of seconds and a few minutes: for example, the second threshold may be arbitrarily set to a duration of the order of one minute. In this case too, different values may be assigned to the second threshold depending on the application under consideration, or depending on the type of signatures associated with one and the same application, for example according to the types of malfunctions associated with these signatures. For example, for a signature of a minor malfunction, not requiring the application to be restarted immediately, the second threshold may be set to a few minutes, whereas, for a signature of a major malfunction, imperatively requiring the application to be restarted immediately, the second threshold may be set to just a few tens of seconds.

According to one feature of the method according to the invention, the step of deactivating an application is carried out as soon as the occurrence parameter in relation to malfunctions of an application is greater than the first threshold and/or as soon as the stability parameter in relation to an application is less than the second threshold.

In other words, the number of occurrences of various signatures, established in the step of analyzing the signatures representative of malfunctions, is compared with the first threshold defined above. At the same time, the average duration between two successive occurrences of these signatures, established in the step of analyzing the signatures representative of malfunctions, is compared with the second threshold defined above, and the invention makes provision for an application to be deactivated as soon as the first threshold and/or the second threshold is crossed.

According to one example, the identification and classification step is carried out prior to a criticality label being assigned to the applications on board the vehicles. In other words, according to this example, all of the signatures of all of the malfunctions of all of the applications, considered to be critical or not, are identified and classified by the communication system according to the invention, and are analyzed thereby. According to this example, the criticality label is then assigned to the applications and taken into account for the possible deactivation of applications assigned the “non-critical” label as explained above. This makes it possible to have a complete and exhaustive database of signatures of malfunctions, in order for example to optimize the operation of all applications, considered to be critical or not, with a view to improving them.

According to another example, the identification and classification step is carried out following a criticality label being assigned to the applications on board the vehicles. In this case, only malfunction signatures occurring for applications assigned the “non-critical” label are identified, classified and analyzed by the communication system according to the invention, with a view to possible deactivation of the corresponding “non-critical” applications. This makes it possible in particular to reduce the amount of information analyzed by the communication system, and thus to achieve faster deactivation of the applications in question.

According to one feature of the invention, the deactivation step is carried out selectively on vehicles present within a geographical area for which the occurrence parameter and/or the stability parameter are higher than one of the thresholds. In other words, the deactivation of an application is then related to the geolocation of the signatures, so as to deactivate applications of vehicles traveling in a geographical area for which a rate higher than the corresponding threshold, and where applicable higher than the corresponding rate for other geographical areas, has been identified.

Other features, details and advantages of the invention will become more clearly apparent from the following description and the drawings, in which:

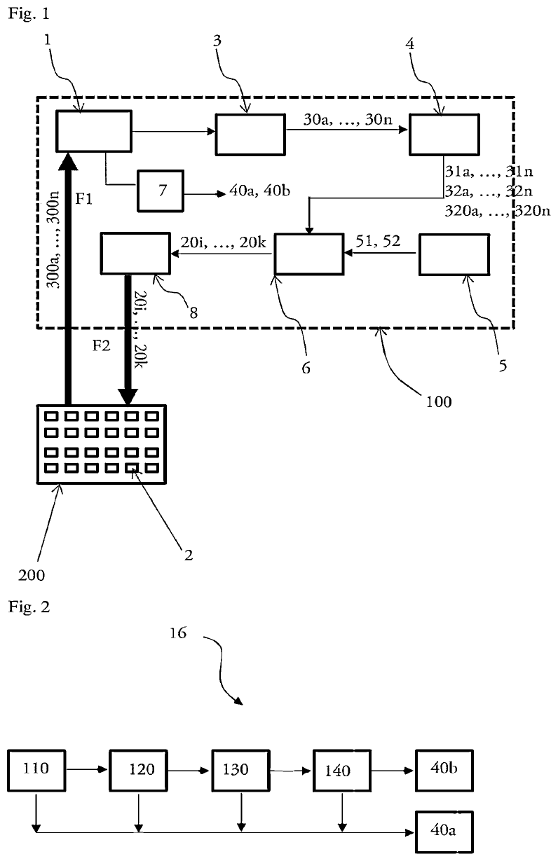

FIG. 1 is a schematic depiction of one exemplary embodiment of the communication system according to the invention,

FIG. 2 schematically illustrates the process of assigning a criticality label to an application on board the vehicles of the set of vehicles,

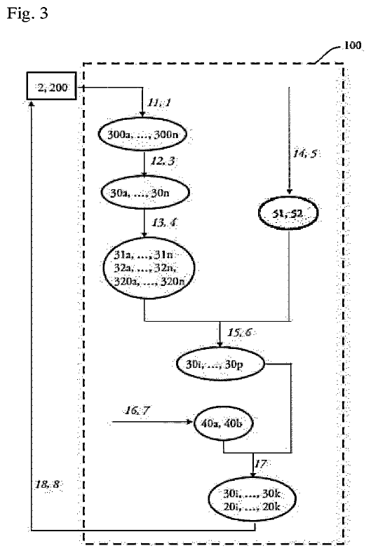

FIG. 3 schematically illustrates a first example of the sequence of the method according to the invention,

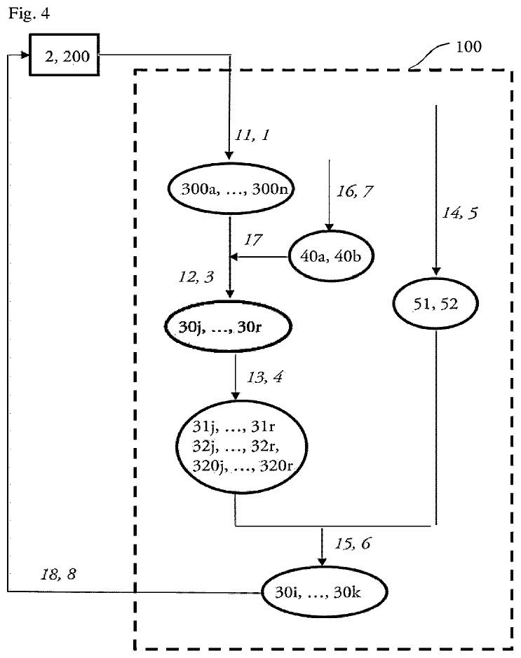

and FIG. 4 schematically illustrates a second example of the sequence of the method according to the invention.

It should first be noted that, although the figures disclose the invention in detail for the purpose of implementing it, they may of course serve to better define the invention where applicable. It should also be noted that, throughout the figures, elements that are similar and/or perform the same function are indicated by the same reference sign.

With reference to FIG. 1, a communication system 100 according to the invention comprises a unit 1 for recording and storing items of information 300a, . . . , 300n transmitted by a plurality of vehicles 2 of a set 200 of vehicles. According to the invention, the items of information 300a, . . . , 300n are transmitted by the vehicles 2 to the recording and storage unit 1 using a communication protocol such as for example the Internet, a communication protocol specific to the vehicle, or a cellular network. As indicated above, the communication system 100 and its elements are therefore remote from the vehicles 2. The transmission of the items of information 300a, . . . , 300n from the vehicles 2 to the recording and storage unit 1 is represented by the arrow F1 in FIG. 1.

The communication system 100 also comprises a member 3 for identifying and classifying, among the items of information 300a, . . . , 300n transmitted by the vehicles 2, signatures 30a, . . . , 30n representative of malfunctions of applications 20a, . . . , 20n on board these vehicles. More precisely, the signatures representative of malfunctions 30a, . . . , 30n comprise a first part 30a′, . . . , 30n′ representative of the application 20a, . . . , 20n that has exhibited a malfunction and a second part 30a″, . . . , 30n″ representative of the nature of the malfunction that has occurred.

The communication system 100 according to the invention also comprises a computing unit 4 configured, respectively:
to count a number of occurrences of the various signatures 30a, . . . , 30n as defined above, and to accordingly determine an occurrence parameter 31a, . . . , 31n;
to measure a duration 32a, . . . , 32n between two successive occurrences of a signature 30a, . . . , 30n under consideration and to compute an average 320a, . . . , 320n of the durations 32a, . . . , 32n thus measured, and to accordingly determine a stability parameter.

The communication system 100 also comprises a parameterization unit 5 configured to give a specific value to a first threshold 51 and to a second threshold 52, with which the occurrence and stability parameters explained above will be compared, respectively. According to the example illustrated more particularly by FIG. 1, the first threshold 51 is identical for all of the applications 20a, . . . , 20n on board the vehicles 2, and the second threshold 52 is identical for all of the applications 20a, . . . , 20n on board the vehicles 2. Each threshold has a value that may be set and implemented in the parameterization unit 5, or else that may change depending on information received by this parameterization unit 5.

The communication system 100 additionally comprises a comparison unit 6 configured firstly to compare the occurrence parameter 31a, . . . , 31n in relation to the various signatures 30a, . . . , 30n with the abovementioned first threshold 51, and secondly to compare the stability parameter 320a, . . . , 320n explained above with the abovementioned second threshold 52, in order to identify the applications 20i, . . . , 20p for which an occurrence parameter 31a, . . . , 31n in relation to signatures 30a, . . . , 30n has a value greater than the value associated with the first threshold 51 or for which a stability parameter 320a, . . . 320n has a value greater than the value associated with the second threshold 52.

The communication system 100 furthermore comprises an assignment member 7 configured to assign, to each application 20a, . . . , 20n on board the vehicles 2, a criticality label 40a, 40b as defined above. For example, applications considered to be critical in the sense defined above are assigned a first criticality label 40a, and applications considered to be non-critical in the sense defined above are assigned a second criticality label 40b.

The communication system 100 finally comprises a communication member 8 configured to transmit, to all of the vehicles 2 of the set of vehicles 200, an order to temporarily deactivate one or more applications 20i, . . . , 20k on board these vehicles as soon as the occurrence parameter 31i, . . . , 31k in relation to signatures 30i, . . . , 30k, . . . , 30n, for these one or more applications, is greater than the value associated with the first threshold 51 or as soon as the stability parameter 320i, . . . , 320k, for these one or more applications, is greater than the value associated with the second threshold 52. The transmission of the order to selectively and preventively deactivate the applications 20i, . . . , 20k is represented by the arrow F2 in FIG. 1.

FIG. 2 schematically illustrates the process of assigning a criticality label 40a, 40b to an application 20a, . . . , 20n on board the vehicles 2 of the set of vehicles 200, such as this process may be implemented by the assignment member 7 explained above.

In a first step 110 of the process, it is analyzed whether the application under consideration 20a, . . . , 20n implements and/or has an implication on a functional element of the core operation of the vehicle, such as, by way of non-exhaustive examples, the operation of the engine or of steering members of the vehicle. If the result of this analysis is “yes”, the first criticality label 40a, or “critical” label, is assigned to the application 20a, . . . , 20n under consideration. If the result of this analysis is “no”, the process moves to its second step 120.

In the second step 120 of the process, it is analyzed whether the application under consideration 20a, . . . , 20n implements and/or has an implication on the connectivity of the vehicle. This may be for example an implication on the ability of the vehicle to communicate with the communication system 100 described above. If the result of this analysis is “yes”, the first criticality label 40a, or “critical” label, is assigned to the application 20a, . . . , 20n under consideration. If the result of this analysis is “no”, the process moves to its third step 130.

In the third step 130 of the process of assigning a criticality label, it is analyzed whether the application under consideration 20a, . . . , 20n implements and/or has an implication on the safety of the vehicle. For example, the application under consideration may implement elements relating to the braking of the vehicle or have an implication on the operation of the lighting thereof. If the result of this analysis is “yes”, the first criticality label 40a, or “critical” label, is assigned to the application 20a, . . . , 20n under consideration. If the result of this analysis is “no”, the process moves to its fourth step 140.

In the fourth step 140 of the process of assigning a criticality label, it is analyzed whether the application under consideration 20a, . . . , 20n is dependent on a process identified as being critical in the preceding steps. For example, the application under consideration may have an implication on the display, intended for the driver of the vehicle, of an item of information relating to a process involving the safety of the vehicle. This may be for example an application that results in there being displayed, on the dashboard, an indicator light indicating a malfunction of a lighting function or of a braking function. If the result of this analysis is “yes”, the first criticality label 40a, or “critical” label, is assigned to the application 20a, . . . , 20n under consideration. If the result of this analysis is “no”, the second criticality label 40b, or “non-critical” label, is assigned to the application 20a, . . . , 20n under consideration.

In summary, the assignment of the “non-critical” label 40b results from the successive elimination of all cases in which the application 20a, . . . , 20n under consideration could intervene in, have an impact on, or result from a process considered to be critical.

FIG. 3 schematically illustrates a first example of the sequence of the communication method according to the invention.

In a transmission step 11 of the method according to the invention, a plurality of items of information 300a, 300b, . . . , 300n are transmitted, by the vehicles 2 of the set of vehicles 200, to the recording and storage unit 1 of the communication system 100. The items of information include signatures 30a, . . . , 30n as defined above, revealing malfunctions of one or more applications 20a, . . . , 20n on board the vehicles 2.

According to the example illustrated more particularly by FIG. 3, a following step of the method according to the invention is a step 12 of identifying and classifying the items of information 300a, . . . , 300n, in the course of which the latter are analyzed in order to identify the abovementioned signatures 30a, . . . , 30n revealing malfunctions of one or more applications 20a, . . . , 20n. With reference to the above, the identification and classification step 12 is carried out for example by the identification and classification member 3 of the communication system 100 according to the invention.

A subsequent step of the method according to the invention consists of a parameter computing step 13, in the course of which the number of occurrences of the various signatures 30a, . . . , 30n for a given application is counted so as thereby to define an occurrence parameter 31a, . . . , 31n in relation to the one or more signatures of this application. As was able to be explained above, the occurrence parameter 31a, . . . , 31n in relation to the signatures may alternatively be computed by multiplying the number of occurrences of the various signatures of one and the same application by the number of vehicles on which these signatures have been identified. At the same time, durations 32a, . . . , 32n between two successive occurrences of a signature 30a, . . . , 30n under consideration may be measured in order to compute an average 320a, . . . , 320n of the durations 32a, . . . , 32n thus measured and thus define a stability parameter in relation to the applications under consideration. These various measuring and counting operations are for example carried out by the computing unit 4 explained above.

Another step of the method according to the invention, which may be carried out simultaneously or offset with respect to the carrying out of the three steps described above, is the step 14 of implementing the first threshold 51 and/or the second threshold 52. This step is for example carried out within the parameterization unit 5 of the communication system 100.

The parameter computing step 13 and the implementation step 14 may be considered to be one and the same analysis step forming part of the method according to the invention, it being understood that, in the context of the invention, the analysis step could be formed solely by the parameter computing step.

A following step of the method according to the invention is a comparison step 15, carried out within the comparison unit 6 described above, in the course of which the various occurrence parameters 31a, . . . , 31n in relation to the various signatures 30a, . . . , 30n, established in the parameter computing step 13, are compared with the value of the first threshold 51 that is implemented, and/or the various stability parameters 320a, . . . , 320n, computed in the parameter computing step 13, are compared with the value of the second threshold 52 that is implemented. In the course of the comparison step 15, the signatures 30i, . . . , 30p for which the occurrence parameter 31i, . . . , 31p is greater than the value of the first threshold 51 and/or the stability parameter 320i, . . . , 320p is less than the value of the second threshold 52 are identified.

The process of assigning a criticality label described above with reference to FIG. 2 consists of an assignment step 16 of the method according to the invention, in the course of which a criticality label 40a, 40b is assigned to the set of applications 20a, . . . , 20n on board the vehicles 2 of the set of vehicles 200.

The following step of the method according to the invention according to the example illustrated by FIG. 3 is a step 17 of sorting the signatures 30i, . . . , 30p previously identified in the comparison step 15 with the criticality labels 40a, 40b assigned to the various applications 20a, . . . , 20n in order to deduce therefrom the applications 20i, . . . , 20k assigned the second “non-critical” criticality label 40b for which the signatures 30i, . . . , 30k were identified in the comparison step 15 as having crossed the first threshold 51 or the second threshold 52, either by the number 31i, . . . , 31k of their occurrences or by the frequency of their repetition, that is to say by the average duration 320i, . . . , 320k between their successive occurrences. In other words, the sorting step 17 of the method according to the invention is a step of sorting, among the signatures 30i, . . . , 30p identified in the comparison step 15 described above as having a number of occurrences 31i, . . . , 31p deemed to be too great or a repetition frequency deemed to be too great, signatures 30i, . . . , 30k corresponding to applications 20i, . . . , 20k assigned a “non-critical” label 40b.

The final step of the method according to the invention is a deactivation step 18, that is to say a step of the communication system 100 as described above and illustrated by FIG. 1 sending a selective order to preventively deactivate the applications 20i, . . . 20k identified in the abovementioned sorting step 17. As indicated above, this deactivation order is sent by the communication system to all of the vehicles 2 of the set of vehicles 200, whether or not the applications 20i, . . . , 20k have exhibited one or more malfunctions on these vehicles, and it takes effect as soon as the vehicles 2 are started, which follows the reception of the deactivation order.

As also indicated above, the preventive deactivation of the applications 20i, . . . , 20k is a temporary deactivation until the detected malfunctions have been resolved, for example by the communication system 100 transmitting an update of the applications 20i, . . . , 20k under consideration to all of the vehicles 2 of the set of vehicles 200.

FIG. 4 schematically illustrates a second example of the sequence of the communication method according to the invention.

This figure shows the various steps, described above and illustrated by FIG. 3, of the method according to the invention. According to this example, however, the step 16 of assigning a criticality label 40a, 40b to the set of applications 20a, . . . , 20n on board the vehicles 2 of the set of vehicles 200 is carried out prior to the identification and classification step 12 described above. This means that the identification and classification step 12 and the following parameter computing step 13, according to this example, are carried out only on the signatures 30j, . . . , 30r corresponding to applications 20j, . . . , 20r assigned the “non-critical” label 40b as defined above or, in other words, the sorting step 17 here is substantially merged with the step 16 of assigning the criticality label 40a, 40b, in order to perform preliminary sorting of the signatures examined in the analysis step 12.

The comparison step 15 described above then results directly in the identification of the signatures 30i, . . . , 30k corresponding to applications 20i, . . . , 20k previously identified as non-critical and having exhibited either a number of malfunctions deemed to be excessively great or a frequency of malfunctions deemed to be excessively great.

The deactivation step 18, that is to say the step of transmitting an order to preventively deactivate the abovementioned applications 20i, . . . , 20k, is carried out in the same way as in the example described above and illustrated by FIG. 3.

The implementation of the method according to the invention according to the second example illustrated by FIG. 4, by carrying out preliminary sorting of the applications according to their criticality label, makes it possible to reduce the number of data analyzed in the parameter computing step 13: it thus makes it possible to save time and energy for the computers of the communication system 100.

The invention as has just been described therefore makes it possible, through simple means, firstly to identify, among the set of applications on board a plurality of vehicles, applications that exhibit a number of malfunctions or a frequency of repetition of these malfunctions deemed to be too great, and secondly to selectively and preventively deactivate such applications.

However, the invention is not intended to be limited to the means and configurations described and illustrated, and also applies to any equivalent means of configurations and to any combination of such means. In particular, as mentioned above, the number and nature of the thresholds 51, 52 may vary and various thresholds may be defined for various groups of applications and/or various groups of types of malfunctions.

1-10. (canceled)

11. A communication system configured to communicate with vehicles of a set of motor vehicles, the communication system comprising:
a unit configured to record and store a plurality of items of information transmitted by a plurality of vehicles of the set of vehicles;
a member configured to identify and classify, among the items of information transmitted by the plurality of vehicles of the set of vehicles, signatures representative of malfunctions of applications on board the vehicles;
a parameterization unit configured to compare, for one of the applications for which at least one signature has been identified and classified, an occurrence parameter in relation to signatures representative of malfunctions of the application with a first predetermined threshold, and/or to compare a stability parameter in relation to the application with a second predetermined threshold; and
a communication member configured to transmit, to at least one vehicle of the set of vehicles, an order to deactivate an application based on a result of the one or more comparisons carried out by the parameterization unit.

12. The communication system as claimed in claim 11, wherein the identification and classification member is configured to assign, to each application on board the vehicles of the set of vehicles, a label representative of a criticality of the application under consideration.

13. The communication system as claimed in claim 12, further comprising a comparison unit that is configured to compare the signature occurrence parameter with the first threshold and/or the stability parameter with the second threshold only for applications that are assigned a certain type of label representative of a criticality of the application under consideration.

14. The communication system as claimed in claim 13, wherein the values associated with the first threshold and/or with the second threshold are functions of the label (representative of a criticality of the application under consideration.

15. A method for communication between the communication system as claimed in claim 11 and the motor vehicles of a set of motor vehicles, the method comprising:
transmitting, from the vehicles of the set of motor vehicles to the recording and storage unit of the communication system, a plurality of items of information relating to the operation of applications board the motor vehicles;
identifying and classifying, among the items of information transmitted by the vehicles, signatures representative of malfunctions of one or more applications on board the vehicles;
analyzing the signatures representative of malfunctions of one or more applications on board the vehicles; and
deactivating, on all of the vehicles of the set of motor vehicles, one or more applications based on a result of the analysis of the signatures representative of malfunctions of these one or more applications.

16. The method as claimed in claim 15, further comprising assigning a criticality label to each application on board the vehicles of the set of motor vehicles.

17. The method as claimed in claim 16, wherein the analyzing the signatures representative of malfunctions of one or more applications on board the vehicles and/or the deactivating the application are conditional upon the criticality label assigned to this application.

18. The method as claimed in claim 15, wherein the analyzing comprises computing an occurrence parameter in relation to the signatures representative of malfunctions of an application and is followed by comparing the occurrence parameter with a value of a first threshold, and/or the analyzing comprises computing a stability parameter in relation to an application and is followed by comparing the stability parameter with a value of a second threshold.

19. The method as claimed in claim 18, wherein the deactivating the application is carried out as soon as the occurrence parameter in relation to malfunctions of an application is greater than the first threshold and/or as soon as the stability parameter in relation to an application is less than the second threshold.

20. The method as claimed in claim 15, wherein the deactivating is carried out selectively on vehicles present within a geographical area for which the occurrence parameter and/or the stability parameter are higher than one of the thresholds.
